(19) United States
(12) Patent Application Publication
(10) Pub. No.: US 2026/0053099 A1
(43) Pub. Date: Feb. 26, 2026

(54) A MODULAR WALL SYSTEM AND A MODULAR WALL

(71) Applicant: Daniel S. SPIRO, Paradise Valley, AZ (US)

(72) Inventor: Daniel S. SPIRO, Paradise Valley, AZ (US)

(21) Appl. No.: 19/101,896

(22) PCT Filed: Aug. 30, 2023
(86) PCT No.: PCT/IB2023/058558

§ 371 Date: Feb. 7, 2025

(30) Foreign Application Priority Data
Sep. 2, 2022 (EP) 22193649.5

(51) Int. Cl. A01G 9/02

(52) U.S. Cl. CPC A01G 9/025

(57) ABSTRACT

A modular wall system has a plurality of elongated wall panels disposed on one another, a plant bedding material tile, a seed/plant cup, a board, and an irrigation pipe. The elongated wall panels have a vertical wall, a top and a bottom flange. The irrigation pipe is disposed on and/or couples to at least one of the top and bottom flanges of an elongated wall panel. The board has an opening configured to receive a seed/plant cup. The board is coupled to at least one of the flanges of the elongated wall panel, thereby forming a wall panel interior. The plant bedding material tile is configured to be coupled to an interior vertical wall portion of the elongated wall panel and/or to an interior wall portion of the board. The seed/plant cup is configured to be inserted from the outside through the at least one opening in the board.

### TECHNICAL FIELD

The invention refers to a modular wall system comprising a plurality of elongated wall panels disposed on one another, a plant bedding material tile, a seed/plant cup, a board and an irrigation pipe. Also, a modular wall is provided.

### TECHNICAL BACKGROUND

Aside from establishing physical separation, in urban settings a modular wall with living plant material can reduce pollutants from the air, reduce the ambient temperature, provide a mounting structure for IOT devices, beautify the urban landscape, and reduce ambient noise. Inside the urban environment, along with nature sounds, noise is generated by humans and machines. Noise is defined as unwanted sound energy traveling by sound waves that for humans is primarily perceived as audible sound. Most urban jurisdictions have rules to regulate noise levels below agreed thresholds that can be measured. Also, in work environments, safety rules limit the amount of noise workers can be subjected to. The human ear is configured to perceive sound in the ranges between 20 Hz and 20 KHz. A normal speaking voice is around 65 dBA. A rock concert can be approximately 120 dBA.

In North America, many jurisdictions set the noise threshold limit to +/−85 dBA to avoid permanent hearing loss, and in work environments safety rules require lesser time exposure for every 3 dBA above the threshold.

In cities, people are regularly exposed to noise. Noise has become an expected by-product of urban life since the Industrial Revolution. Unfortunately, this by-product is known to disrupt people's sleep patterns and induce stress, resulting in negative health outcomes.

While guardrails to curtail excessive noise have been placed in most jurisdictions, there is no system in place that would encourage noise polluters to reduce or eliminate the noise they generate.

The present innovation aims to subdue this myriad of noises by natural and sustainable means. Further, the present innovation expands on the art described in U.S. patent application Ser. No. 16/805,093, articulating an acoustic solution to subdue noise in proximity to the modular vertical wall, that can also grow plant material.

US2011/225883 discloses a vegetation wall for supporting vegetation.

JP 2011125260A discloses an exterior or interior wall for planting vegetation.

JP2006280285A discloses a green wall using capillary action.

US2022039327A discloses an automated outdoor modular vertical plant cultivation system forming a vertical structure.

### SUMMARY OF THE INVENTION

An object of the present invention is to provide a modular wall system that at least partly overcome the drawbacks and issues mentioned above.

These and other objects are solved by a modular wall system comprising a plurality of elongated wall panels disposed on one another, a plant bedding material tile, a seed/plant cup, a board, and an irrigation pipe, wherein:
the elongated wall panels comprise a vertical wall, a top flange and a bottom flange;
the fluid emitting irrigation pipe is disposed on and/or couples to at least one of the top and bottom flanges of an elongated wall panel;
the board comprises at least one opening configured to receive a seed/plant cup, and wherein the board is coupled to at least one of the flanges of the elongated wall panel, thereby forming a wall panel interior;
the plant bedding material tile is configured to be coupled to an interior vertical wall portion of the elongated wall panel and/or to an interior wall portion of the board;
the seed/plant cup is configured to be inserted from the outside through the at least one opening in the board to thereby be partially disposed inside a cup bedding material opening of the plant bedding material tile; and wherein
once irrigated by a fluid supply provided by the fluid emitting irrigation pipe, a seed/plant in the seed/plant cup disposed inside the plant bedding material tile is configured to grow roots into the plant bedding material and grow a canopy extending from an exterior of the board.

Accordingly, a modular wall system is provided that is based on vertically disposed elongated wall panels that are configured to be arranged in a shelf-like manner one on top of the other. The elongated panels are configured to support one or more plant bedding material tiles. Also, a board is configured to couple to at least one of the flanges of a respective elongated panel to thereby form a wall panel interior. The board comprises openings allowing the insertion of seed/plant cups into corresponding openings in the plant bedding material tile. By the integrated irrigation system, the seeds/plants are allowed to grow and form canopies that extend from the interior of the wall system out and along/across the exterior surface of the boards. Accordingly, the invention provides a living wall that contributes to the reduction of pollutants from the air, reduces the ambient temperature, contributes to the beauty of the urban landscape and, not at least reduces ambient noise. By the modularity, the length, and the height of the wall may be easily adapted to actual circumstances. Also, by the provision of boards and plant bedding material tiles, each of them having mating openings, the type of plants may be easily exchanged over the seasons if necessary and also the choice of plant bedding material may be adapted to the choice of plants.

The vertical modular wall system allows the formation of a wall by arranging the vertical wall panels one on top of the other in a shelf-like manner. The vertical panels can be single or double sided to retain plant bedding material and/or boards on one side of the wall and/or on both sides. Thus, the two opposing sides of the resulting wall may be provided with different appearance and different properties.

The boards may be solid boards or be acoustic boards. Each elongated wall panel may comprise a combination of solid boards and acoustic boards, the boards being distributed along the longitudinal extension of the wall panel. Also, not all boards must be provided with holes configured to receive seed/plant cups.

In yet in another alternate configuration, sound attenuating material can be coupled to the interior vertical wall of the elongated wall panel and/or to the interior face of the solid or acoustic board that encloses the wall panel interior from the exterior. In all scenarios, the plant bedding material and/or the sound attenuating material is disposed between the vertical wall panel and the solid/acoustic board, wherein the top and bottom flanges of the elongated wall panel couple to the solid/acoustic board to form an enclosure.

In at least one embodiment, the fluid can drip from above onto the plant bedding material tile below. This is allowed in the event the irrigation pipe is arranged along either a top or bottom surface of the top flange of the respective elongated wall panel. One or both of the top and bottom flanges may be provided with weep holes. In another embodiment, the fluid can irrigate the plant bedding material tile from below. In such event, the irrigation pipe may be arranged along e.g. the bottom flange of the respective elongated wall panel.

Openings in the plant bedding material tile and the solid/acoustic boards enable seeds/plant cups to be inserted from the exterior surface of the solid/acoustic board into said pre-fabricated opening/s. Once irrigated, the plant/s' roots grow into the bedding material, thereby anchoring the plant/s.

The board may in one embodiment be an acoustic board. The board may in alternative embodiment be a non-acoustic board.

The board, no matter if it is solid or acoustic, may have at least one sound attenuation through opening. At least one of: the size, the quantity, the form, the thickness, and/or the location of the openings in the sound attenuation may be configured to attenuate sound level intensity and/or frequency by local ambient conditions. At least one of the plant bedding material tile and the seed/plant cup may exhibit sound attenuation properties.

The board may comprise a bore configured to couple the board to the elongated wall panel by means of a mechanical fastener. The mechanical fastener may by way of example be a screw or a clip.

The board may be removably fixated between the top and bottom flanges of the elongated wall panel. The board may be openable by a tilting movement while being supported by one of the top and bottom flanges.

The modular wall system may comprise at least two single-sided or double-sided elongated wall panels.

A flange of a first elongated wall panel may be configured to be coupled to a flange of a second elongated wall panel by at least one reciprocating mechanical key. The reciprocating mechanical key may be formed as an undulating pattern having an extension in parallel with the elongated extension of the wall panel. The undulating pattern of the mechanical key of the top flange of a first elongated wall panel may be complementary to the undulating pattern of the mechanical key of the bottom flange of a second elongated wall panel.

The top and bottom flanges of the elongated wall panels may comprise weep holes. The number of weep holes and also their positions may correspond to the number and positions of cup bedding material openings of the plant bedding material tiles. Thereby, each seed/plant may be properly irrigated.

The plant bedding material tile may comprise at least one funnel. The at least one funnel may be substantially vertically aligned with a respective cup bedding material opening in the plant bedding material tile. The number of funnels and their positions may correspond to the cup bedding material openings of the plant bedding material tile. Thereby, each seed/plant may be properly irrigated.

The plant bedding material tile may be configured to be coupled to the board and/or to a plant bedding material casing. The casing may be seen as a protection that facilitates handling of the tile and also that prevents the tile from disintegrating and crumbling over time.

According to another aspect, the invention relates to a modular wall formed by the use of a modular wall system with the features according to any of claims 1-12, wherein a plurality of elongated wall panels are arranged in stacked relationship, one on top of the other, between at least two vertically extending posts.

The modular wall may be formed by at least two single-sided or double-sided
elongated wall panels and at least one of the sides of the modular wall may comprise a plurality of seed/plant cups. According to yet another aspect, the invention refers to an elongated wall panel to form part of a modular wall system according to any of claims 1-12, wherein the elongated wall panel is partially or fully, made of a bio-degradable material.

According to yet another aspect not forming part of the invention, a modular wall system is provided. The modular wall system comprises a plurality of elongated wall panels disposed on one another, a plant bedding material tile, a seed/plant cup, and an acoustic board; wherein
the elongated wall panels comprise a vertical wall, a top flange and a bottom flange;
the acoustic board comprises at least one opening configured to receive a seed/plant cup, and wherein the acoustic board is configured to couple to at least one of the top flange and bottom flange of the elongated wall panel, thereby forming an elongated wall panel enclosure;
the plant bedding material tile is configured to be coupled to an interior vertical wall portion of the elongated wall panel and/or to an interior wall portion of the acoustic board, and wherein the plant bedding material tile comprises at least one cup bedding material opening;
the seed/plant cup is configured to be inserted from the outside through the at least one opening in the acoustic board and to be partially disposed inside one of the at least one cup bedding material openings of the plant bedding material tile; whereby
a supply of plant irrigation fluid is configured to flow along the elongated wall panel inside the elongated wall panel enclosure; and whereby
exterior ambient sound, at least in part, is configured to be absorbed and attenuated by the acoustic board, the seed/plant cup, the plant bedding material tile, and a plant growing from the seed/plant cup.

The modular wall system of this alternative aspect has a similar overall design as the system described above. Hence, the features and advantages discussed above are equally applicable to this embodiment.

At least one of: the size, the quantity, the form, the thickness, and/or the location of openings in the acoustic board may be configured to attenuate sound level intensity and/or frequency by local ambient conditions.

The acoustic board may comprise a bore configured to couple the acoustic board to the elongated wall panel by means of a mechanical fastener.

The acoustic board may be configured to be removable fixated between the top and bottom flanges of the elongated wall panel. The acoustic board may be openable by a tilting movement while being supported by one of the top and bottom flanges.

The modular wall system may comprise at least two single-sided or double-sided elongated wall panels.

A flange of a first elongated wall panel may be configured to be coupled to a flange of a second elongated wall panel by at least one reciprocating mechanical key.

The plant bedding material tile may be configured to be coupled to the acoustic board and/or to a plant bedding material casing.

The elongated wall panels may, partially or fully, be made of a bio-degradable material.

The board may, partially or fully, be made of a bio-degradable material. This applies, no matter if the board is acoustic or non-acoustic. The outer surface of the board configured to face away from the interior of the wall system, may be provided with a surface treatment to protect the same from degrading due to UV exposure.

According to yet another aspect not forming part of the invention, a modular wall system comprising a plurality of elongated wall panels disposed on one another is provided. The modular wall system comprises a sound attenuation material tile and an acoustic board; and wherein:
the elongated wall panels comprise a vertical wall, a top flange and a bottom flange;
the top flange of a first lower elongated wall panel is coupled to the bottom flange of a second upper elongated wall panel by at least one reciprocating mechanical key;
the acoustic board with at least one sound attenuation opening is configured to couple to at least one flange of a respective elongated wall panel to thereby enclose an interior space in said elongated wall panel;
the sound attenuation material tile is configured to be disposed inside the interior space formed by the elongated wall panel and the acoustic board; whereby
exterior ambient sound, at least in part, is absorbed and attenuated by the acoustic board and the sound attenuation material tile being disposed inside the elongated wall panel of the modular wall.

The modular wall system of this additional alternative aspect has a similar overall design as the system described above. Hence, the features and advantages discussed above are equally applicable to this embodiment.

The acoustic board may comprise at least one opening for a seed/plant cup.

The sound attenuation material tile can couple to at least one seed/plant cup.

The acoustic board can couple to a sound attenuation material tile.

The sound attenuation material tile may be a plant bedding material tile and the acoustic board can couple to a plant bedding material casing encircling the sound attenuation material tile. At least one of: the size, the quantity, the form, the thickness, and/or the location of the openings in the sound attenuation tile may be configured to attenuate sound level intensity and/or frequency by local ambient conditions.

The acoustic board may be configured to be detachable and secured to the elongated wall panel by a mechanical fastener.

The acoustic board may be configured to be removably fixed between the top and bottom flanges of the elongated wall panel.

The elongated wall panels may, partially or fully, be made of a bio-degradable material.

The acoustic board may, partially or fully, be made of a bio-degradable material.

The outer surface of the acoustic board configured to face away from the interior of the wall system, may be provided with a surface treatment to protect the same from degrading due to UV exposure.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIGS. 1a and 1b show single- and double-sided wall panel sections, respectively.

FIGS. 2a and 2b show front and back perspective views of a plant bedding material panel, respectively.

FIGS. 3a and 3b show front and back perspective views of a plant bedding material casing, respectively.

FIGS. 4a and 4b show front and back perspective views of an acoustic board, respectively.

FIG. 5a shows a perspective view of a seed/plant cup and FIG. 5b shows a partial enlarged section of a seed/plant cup inserted into a modular wall panel.

FIGS. 6a and 6b show in perspective view mechanical means to couple the plant bedding material casing to an acoustic board, and the elongated wall panel, respectively.

FIGS. 7a and 7b show exemplary methods of removable and fixed coupling of the acoustic board to the flanges of the wall panel, respectively.

FIGS. 8a and 8b show exemplary single- and double-sided wall panel sections with the plant bedding material inside the casing coupled to an exterior facing acoustic board, respectively. FIG. 8c shows a back-to-back single sided wall section configuration with an air gap between the wall panels.

FIGS. 9a and 9b show front and back exploded perspective views of the wall panel assembly, including the plant bedding material and the acoustic board, respectively.

### DETAILED DESCRIPTION OF EMBODIMENTS OF THE INVENTION

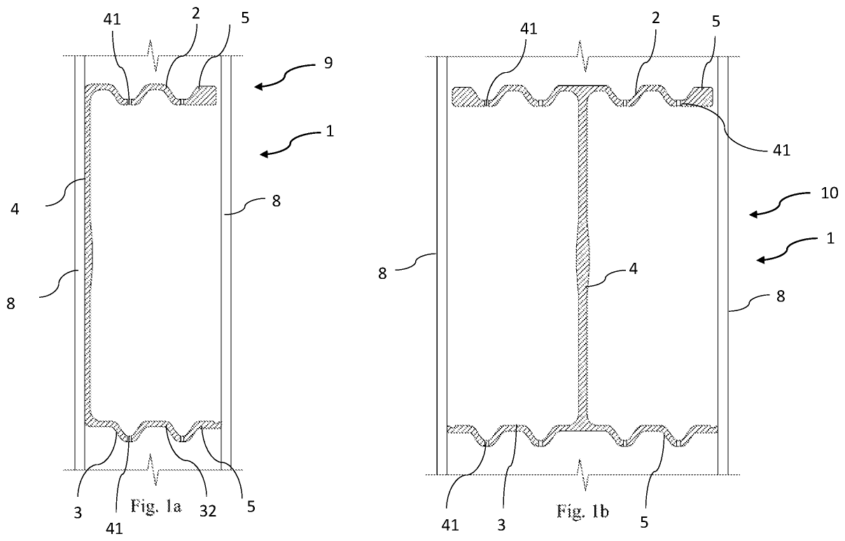

In the following one embodiment of the invention will be discussed with reference to the drawings. FIGS. 1a and 1b show single- and double-sided wall panel 9, 10 sections, respectively.

FIG. 1a shows a transverse section of a “C” shaped single-sided elongated wall panel 9. The elongated wall panel 9 comprises a vertical wall 4, a top flange 2 and a bottom flange 3. The flanges 2, 3 show mechanical keys 5. The mechanical keys 5 are disclosed as having an undulated pattern. The reciprocating mechanical key, no matter pattern, may have an extension in parallel with the elongated extension of the wall panel. The undulating pattern of the top flange 2 of a first elongated wall panel may be complementary to the undulating pattern of the mechanical key of the bottom flange 3 of a second elongated wall panel. It is to be understood that other types of mechanical keys may be equally applied. The mechanical keys 5 are configured to interlock with elongated wall panels 9, placed above and/or below a first wall panel 9. Accordingly, the top flange 2 of a first lower elongated wall panel 9 is configured to lockingly engage the bottom flange 3 of a second upper elongated wall panel 9. Thus, a plurality of elongated wall panels 9 are configured to be vertically stacked, one on top of the other.

The present figure's single-sided cross-section can be configured to retain plant material and/or a board on one side of the single-sided wall panel 9.

The top and bottom flanges 2, 3 do both comprise through-going weep holes 41. The weep holes will be further discussed below.

Now turning to FIG. 1b, a transverse section of a double-sided elongated wall panel 10 is shown. The elongated wall panel 10 has an overall “I” shaped cross-section. The elongated wall panel 10 comprises a vertical wall 4, a top flange 2 and a bottom flange 3. The flanges 2, 3 show mechanical keys 5. The mechanical keys 5 are disclosed as having an undulated pattern. The undulating pattern of the top flange 2 of a first elongated wall panel may be complementary to the undulating pattern of the mechanical key of the bottom flange 3 of a second elongated wall panel. It is to be understood that other types of mechanical keys may be equally applied. The mechanical keys 5 are configured to interlock with elongated wall panels 10, placed above and/or below a first wall panel 10. Accordingly, the top flange 2 of a first lower elongated wall panel 10 is configured to lockingly engage the bottom flange 3 of a second upper elongated wall panel 10. Thus, a plurality of elongated wall panels 10 are configured to be vertically stacked, one on top of the other.

The top and bottom flanges 2, 3 do both comprise through-going weep holes 41. The weep holes will be further discussed below.

No matter if the elongated wall panel 9, 10 is a single sided or a double-sided wall panel, one or both of the flanges 2, 3 is formed or adapted to retain a means of conveying fluid and/or electricity. This will be further explained below. In addition, one or both of the flanges 2, 3 is configured to retain a solid or acoustic board (omitted in FIGS. 1a and 1b) and/or to have a means to fasten a solid/acoustic board to one or both of the flanges 2, 3. This will be further discussed below.

Further, no matter if the elongated wall panel 9, 10 is a single- or double-sided panel, the elongated wall panel 9, 10 is an elongated structure configured to distribute its weight laterally along its bottom flange 3 surface. An arrangement of wall panels 1, with two or more elongated wall panels 9, 10 arranged above one another, is configured to be secured to or supported by at least two vertical posts 8 disposed at the opposite ends of the elongated wall panels 9, 10. The posts 8 are only illustrated highly schematically.

The elongated wall panels 9, 10 can be fabricated by methods of: pultrusion, extrusion, 3D printing, and pressure forming. The elongated wall panels 9, 10 can be made of metallic or non-metallic material that can be noncorrosive and inert to the elements where it is placed. The elongated wall panels 9, 10 may alternatively be formed by a combination of metallic and non-metallic material. The elongated wall panels 9, 10 may fully or partly be formed by a polymeric material. The polymeric material may be a reinforced material, e.g., a fibre reinforced material.

The elongated wall panels 9, 10 may be partially or fully formed by an organic bio-degradable material(s) (including resin materials) having at least one of non-metallic, non-conductive, non-flammable and non-corrosive property/ies. In addition, the structural integrity of the sections employing the organic biodegradable material should preferably remain intact at least between the temperatures of −40° C. to 180° C.

Non-limiting examples of organic, bio-degradable materials include bioplastics such as biopolyethylene, thermoplastic polyester such as polylactide (PLA), polybutylene succinate, or polyhydroxyalkonate (PHA). In addition to being bio-based and biodegradable, PHA does not leave bioplastics behind. An example commercially available PHA product is PHAx622, part of the brand PHAradox.

In addition, bio-degradable materials used as strengthening materials may be combined with the above-described materials to enhance the mechanical properties of the composite materials. As one non-limiting example, degradable, reinforcing glass fiber (like that used by ArcBiox™ from Arctic Biomaterials, Tampere, Finland) may be combined with PHA to create a fully biodegradable material that has enhanced structural integrity and heat resistance as compared to using PHA alone. The glass fiber reinforcement to PHA, provided by the degradable reinforcing glass fibers, serves a similar role to glass fibers added to resin in fiberglass to provide a composite material with much stronger mechanical properties than either resin or glass fibers alone. Non-limiting example products that may be used to enhance mechanical, temperature and manufacturing processes include (1), ArcBiox™ BSGF-series bio-degradable materials which include degradable glass fibers, (2) ArcBiox™ MFA-series bio-based materials which includes minerals as a reinforcing agent, (3) ArcBiox™ B-series bio polyester materials, and (4) ArcBiox™ A-series PLA materials which use approximately 90% bio-content. As one non-limiting example, the ArcBiox™ BSGF20-B2012 (data from preliminary technical data sheet) at 23° C. provides flexural strength of 110 MPa, tensile stress at yield of 70 MPa, tensile strain at yield of 2%, tensile modulus of 5600 MPa, heat deflection temperature at 0.45 MPa of 110° C., density of 1.4 g/cm³, and melt flow rate at 190° C./2.16 kg, 200° C./5 kg of 15 and 45 g/10 min respectively. The skilled person realizes that the given examples are non-limiting examples. Other bio-degradable strengthening materials include plant fibre, such as e.g., hemp fiber.

The present figure's cross-section can be configured to retain plant material and/or plant material and boards on one or both sides of the double-sided wall panel 10. Thus, one side may be configured to retain plant material whereas the other side may be configured to retain a board. Also, one and the same side may be configured to retain a combination of boards and plant material. As will be discussed below, the board may be of an acoustic or non-acoustic material.

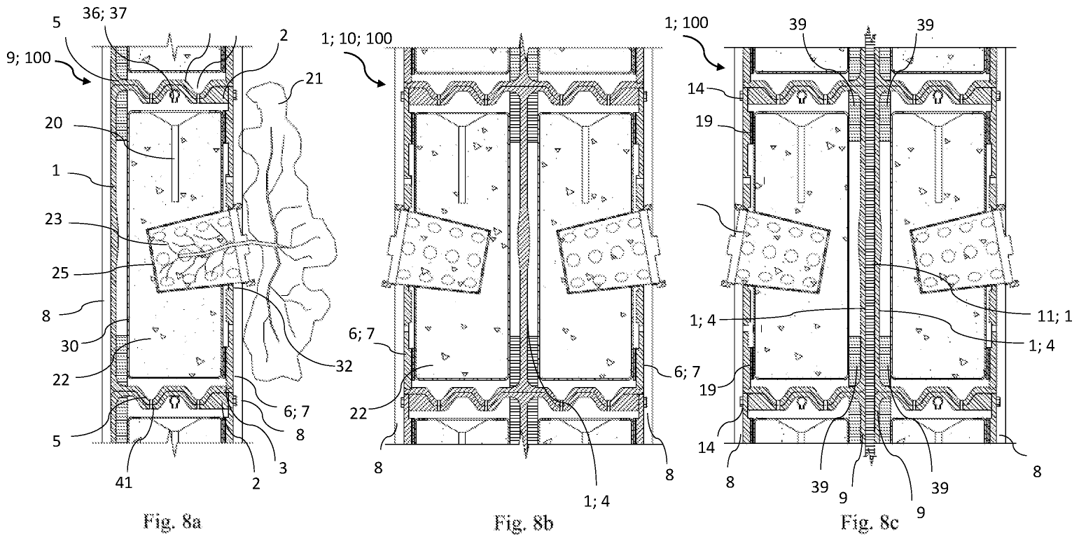

In another arrangement, see FIG. 8c, a modular wall 100 according to the invention can be comprised of two single-sided wall panels 9 disposed back-to-back to one another with an air gap 11 between them, or with a barrier member 12. The barrier member 12 can have several a single or multiple uses further described in more detail herein.

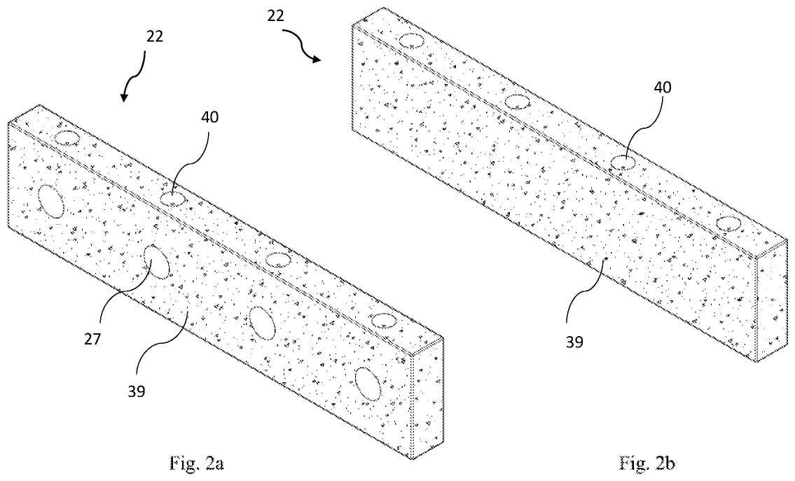

Now turning to FIGS. 2a and 2b, which show front and back perspective views of a plant bedding material tile 22, respectively.

FIG. 2a shows in perspective view a plant bedding material tile 22. The plant bedding material tile 22 can be fabricated of organic material that can be comprised of coconut fiber, wood chips, pulverized tree bark, and/or similar material. In other embodiments, the plant bedding material tile 22 can also be comprised of manufactured fiber such as mineral wool or rock wool. The plant bedding material tile 22 is configured to provide an anchoring medium for plants' roots. In addition, the plant bedding material tile 22 can retain and provide humidity, minerals and additives for the plants.

The plant bedding material tile 22 can be formed in a mold under pressure. The plant bedding material tile 22 can have varying thicknesses and profiles. To harden the tile, the plant bedding material aggregate can be mixed with a binder. The binder material can be produced by nature, having no harmful environmental impact. In addition, at least one plant bedding material tile 22 can be pre-seeded.

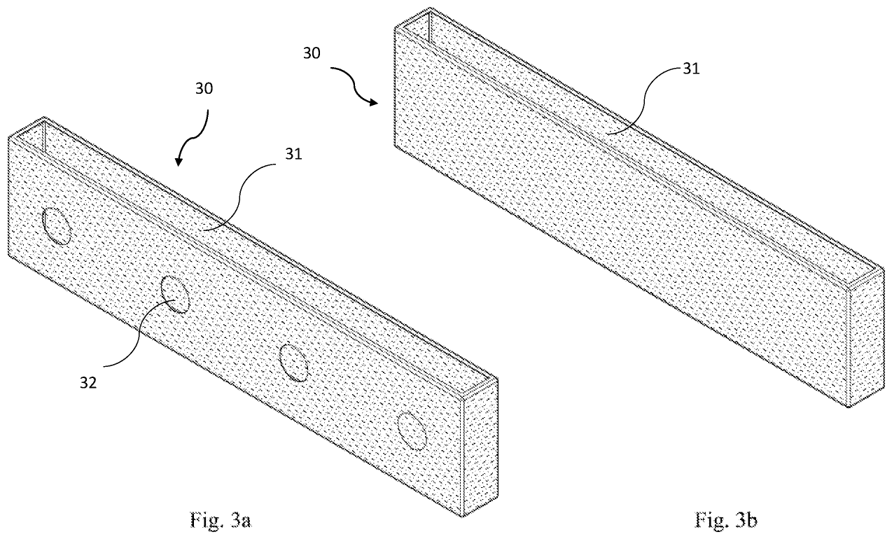

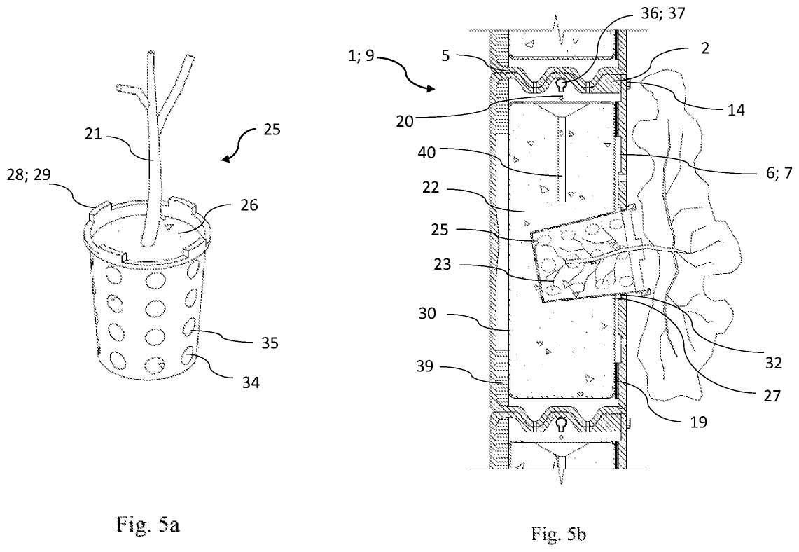

The plant bedding material tile 22 is formed with at least one cup bedding material opening 27 configured for a seed/plant cup (see FIG. 5b). The at least one cup bedding material opening 27 is arranged in one of two opposing vertical side walls of the plant bedding material tile 22. The opening 27 does preferably have a non-horizontal extension. The cup, as will be discussed below, is configured to be inserted through a casing and/or a board which as such may be solid/acoustic. For reasons of durability, the plant bedding material tile 22 can be placed in a fabric casing 30, as shown in FIGS. 3a and 3b.

As is shown in FIG. 2a, the present figure shows a funnel 40 on the top wall of the plant bedding material tile 22. The funnel 40 can be at least partially formed as a recess in the bedding material tile 22 and/or be a separate member to be inserted upon installation of the plant bedding material tile 22.

The plant bedding material tile 22 is configured to be positioned below an irrigation pipe as will be further discussed below with reference to FIG. 5b. Irrigation fluid can then flow by gravity and/or under pressure to the plant bedding material tile 22 disposed below. The irrigation fluid is preferably configured to be supplied from the irrigation pipe to the one or more funnels 40 in the plant bedding material tile 22 in a manner to be described below.

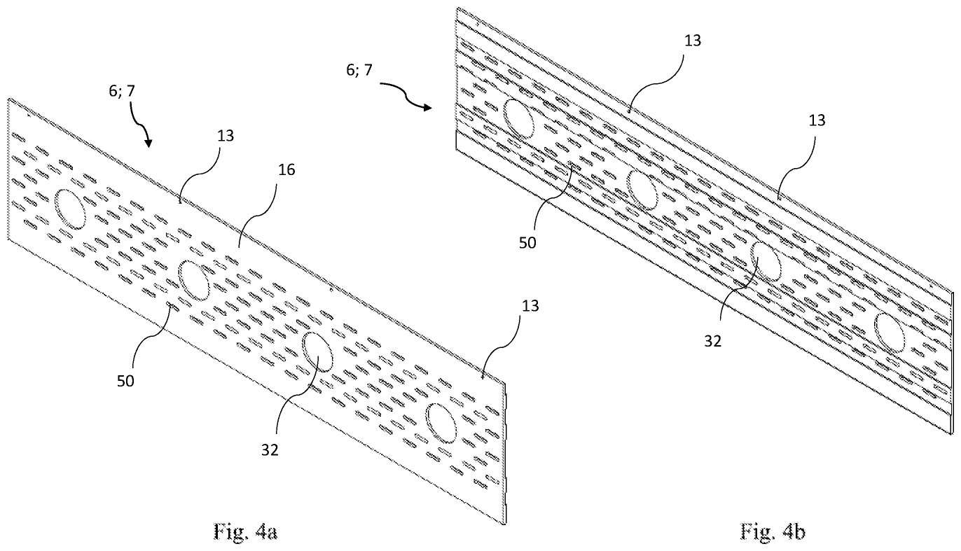

FIG. 2b shows a back side perspective view of the plant bedding material tile 22. The back side of the plant bedding material tile 22 is configured to face an inner portion of the vertical wall panel 4 of an elongated wall panel 9, 10. The back side of the plant bedding material tile 22 surface is solid, i.e. without any cup-receiving openings. The plant bedding material tile 22 can be configured to couple to the vertical wall panel 4 of the elongated wall panel 9, 10 and/or to a solid/acoustic board 6, 7 that couples to at least one flange 2, 3 of the wall panel 9, 10. The board 6, 7 will be further discussed below with reference to FIGS. 4a and 4b.

The plant bedding material tile 22 has sound attenuation properties that can vary by at least one of: the material thickness, density, material, and moisture absorbance capability. In at least one embodiment where plant material is not used, sound attenuation material 39 can be used in lieu of plant bedding material tile 22 of similar or better sound attenuation properties. Thus, the principle as is disclosed in FIGS. 2a, 2b is equally applicable in the event the tile instead of being made of a plant bedding material is made of sound attenuating material to thereby constitute a sound attenuating tile. The skilled person realizes that is such case, any cup bedding material openings 27 and funnels 40 may be omitted.

Now turning to FIGS. 3a and 3b which show front and back perspective views of a plant bedding material casing 30, respectively.

FIG. 3a shows a perspective view of the plant bedding material casing 30. The casing 30 form substantially emulates the plant bedding material tile 22 form. The plant bedding material tile 22 is configured to be disposed inside the casing 30.

The casing's 30 prime purpose is to keep the tile 22 form intact and to prevent the tile's 22 organic material from crumbling once the tile 22 comes in contact with fluid 20. The tile 22 material expands upon coming into contact with fluid 20. The casing 30 limits the rate of expansion while maintaining the tile's 22 form

As a secondary attribute, the casing 30 provides is a good contact surface for coupling the plant bedding material tile 22 to the vertical wall 4 of the elongated wall panel 9, 10 and/or to an interior surface of the solid or acoustic board 6, 7 (not shown) coupled to at least one of the top and bottom flanges 2, 3. Further, the plant bedding material tile 22 can be encased inside a casing 30 and the casing 30 can then couple to the vertical portion of the vertical wall 4 and/or the solid/acoustic board 6, 7.

The present figure shows a top surface opening 31 for the insertion of a plant bedding material tile 22. In a different embodiment, this surface 31 can be fully or partially enclosed following the insertion of the plant bedding material tile 22. On the exterior facing side of the casing 30, four plant cup openings 32 are shown configured to receive seed/plant cups 25 through the casing 30 into the plant's bedding material tile 22.

The casing 30 can be made of non-organic or organic material fabric such as hemp or canvas, with a weave pattern that reduces irrigation fluid 20 egress. In addition, at least a portion of the casing 30 can be treated to become partially or fully non-permeable.

FIG. 3b shows the back side of the plant bedding material tile casing 30. The back side of the plant bedding material tile casing 30 is configured to face the inner vertical wall of the wall panel 4 of the elongated wall panel 9, 10. The back side of the casing 30 can in at least one embodiment be figured to couple to the vertical wall 4 of an elongated wall panel 9, 10.

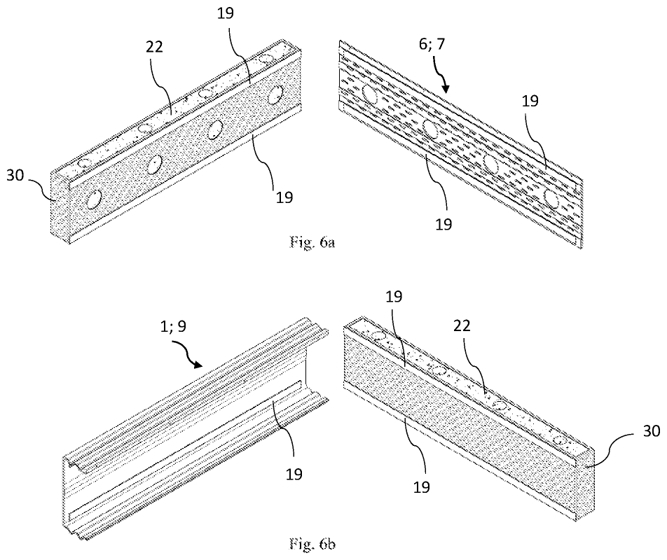

The skilled person realizes that the bedding material casing 30 may be omitted, depending on the physical properties/inherent strength of the plant bedding material tile 22. Thus, the bedding material tile 22 can be configured to couple directly to the vertical wall 4 of the elongated wall panel 9, 10 and/or to the inner face of a board 6, 7 similarly to mounting the casing 30 as shown in FIGS. 6a and 6b.

In the event the tile instead should be operable as a sound attenuation tile, such tile may be configured to be disposed inside the casing 30. It is realized that the plant cup openings 32 in such case can be omitted.

Now turning to FIGS. 4a and 4b which show front and back perspective views of an acoustic board 7, respectively. The description is equally, unless not explicitly stipulated, applicable to a solid board 6.

FIG. 4a shows a perspective view of an acoustic board 7. The acoustic board 7 is configured to couple to at least one of the top and bottom flanges 2, 3 of a elongated wall panel 9, 10 in a manner that will be discussed below. The acoustic board 7 is configured to be disposed on the exterior face of the modular wall 100. The acoustic board 7 is configured to help attenuation of ambient noise, to provide a mounting structure for a seed/plant cup 25, to protect the irrigation system and the plant bedding material 26 in the plant bedding material tile 22 from vandals, to protect any electrical devices retained inside an arrangement of wall panels 1 from thieves, and to help aeration of the plant bedding material 26.

The board's exterior surface can also be configured to receive graphic print. Such print can show pattern and colour in the form of imagery and text. The present figure shows three types of openings in the exterior face of the acoustic board: openings 32 for a seed/plant cup; openings 50 that dampens sound; and bore openings 13 for coupling the acoustic board 7 to a support structure.

The board 6, 7, no matter if the board has acoustic or non-acoustic material, may be formed by the same type of material as the elongated wall panels 9, 10. Hence, the board 6, 7 may be made of metallic or non-metallic material that can be noncorrosive and inert to the elements where it is placed. The board 6, 7 may alternatively be formed by a combination of metallic and non-metallic material. The board 6, 7 may fully or partly be formed by a polymeric material. The polymeric material may be a reinforced material, e.g., a fibre reinforced material. The board 6, 7 may be partially or fully formed by an organic bio-degradable material(s) (including resin materials). Also the reinforcing material, if any, may be bio-degradable materials. To avoid undue repetition, the examples relating to materials given above in view of the elongated wall panels 9, 10 are equally applicable to the board 6, 7.

The acoustic board 7 is configured to receive at least one seed/plant cup 25 (see e.g. FIG. 5b) through a respective opening 32. The opening 32 is sized to be compatible with a seed/plant cup 25.

Further, in at least one embodiment, a mechanical keying element can key and/or lock a seed/plant cup 25 to the acoustic board 7 (not shown).

The acoustic board 7 comprises a pattern with a plurality of sound attenuation openings 50. Instead of openings 50, recesses may be arranged to fulfil the same purpose. The openings 50 are configured to break down the sound wave pressure, and to let a portion of the sound to be absorbed by a plant bedding material tile 22 that is configured to be arranged behind the board 7. The sound absorption properties of the plant bedding material 26 in the tile 22 is significant and, coupled with plant material 21 growing on the acoustic board 7, the acoustic board 7 together with the plant bedding material tile 22 can substantially reduce urban noise. The quantity, size, form, thickness and location of the sound attenuating openings 50 can be preconfigured to mitigate a specific environment's noise level intensity and frequency.

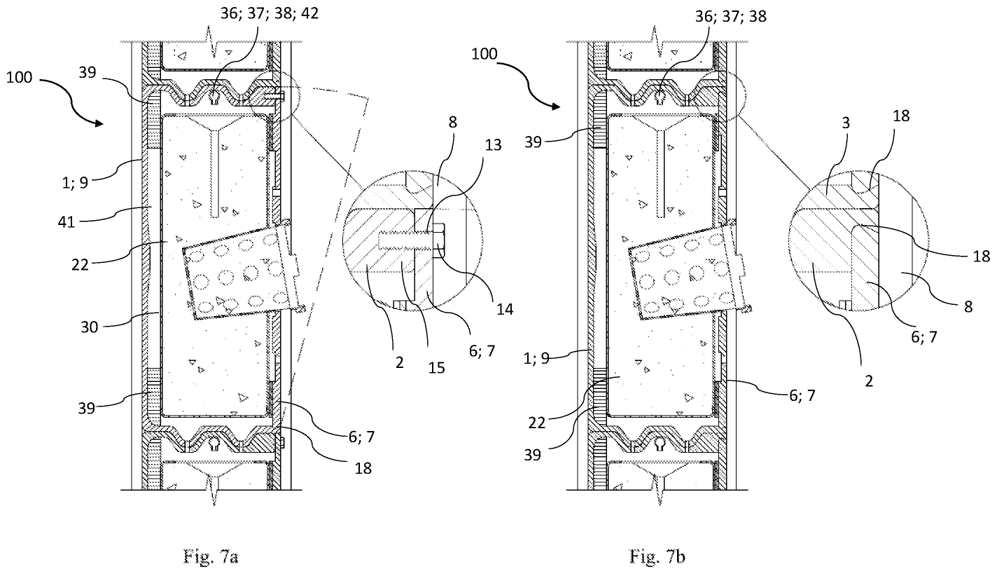

The at least one bore 13 can be used to secure the acoustic board 7 to a retaining structure. In FIG. 7a, the present innovation shows such a means of securing the board 7 to a top flange 2 of a wall panel 1. In this figure, at least one mechanical fastener 14 in the form of a screw couples the acoustic board 7 to a protrusion 15 built into the top flange 2 of the elongated wall panel 9. The same principle is equally applicable in the event of a double-sided elongated wall panel 10. In another embodiment, see FIG. 7b, the acoustic board 7 can be secured to a top and a bottom flange 2, 3 of the elongated wall panel 9 with no need for any mechanical fastener 14. In this embodiment, the upper and lower edges of the acoustic board 7 are held in place by corresponding elongated counter channels 18 in the top and bottom flanges 2, 3.

In yet another embodiment, in lieu of an acoustic board 7, a solid board 6 can be used, with the same or similar means as the acoustic board 7 to couple it to a retaining structure. As with the acoustic board 7, the solid board 6 can have at least one opening 32 to receive a seed/plant cup 25. In addition, the exterior surface of the solid board 6 can be painted and can display graphic images and/or text. The solid board 6 can have no explicit acoustic properties.

The surfaces of both the solid and the acoustic boards 6, 7 are washable and can have a protective membrane 16 layer that makes the removal of graffiti easier. Both the solid and acoustic boards' 6, 7 thicknesses are configured to minimize the boards' 6, 7 weight without compromising their respective performances.

At least the outer surface of the board 6, 7, may be provided with a surface treatment to protect the same from degrading due to UV exposure.

The size of the solid and acoustic boards 6, 7 is governed by the clear height between the top and bottom flanges 2, 3 of the elongated wall panel 9, 10. The skilled person realizes that the boards may include optional (not illustrated) unitarily formed or non-unitarily formed stiffeners to protect the boards from cross impact. The length of the solid or acoustic board 6, 7 can be configured to meet industry standards and ease of shipping and installation.

FIG. 4b shows the back side of the acoustic board 7. This side is configured to face the interior vertical wall 4 of an elongated wall panel 9, 10. The openings shown 32, 50, 13 include the same openings described in FIG. 4a, inferring that the present embodiment openings are through openings.

Also, as shown in FIG. 4a and even better in FIG. 7a, at least the bottom longitudinal end of the acoustic board 7 is rounded. Rounding the bottom longitudinal end of the acoustic board 7 enables installation and removal of the board 7 by pulling the board 7 from a bottom flange 3 of an elongated wall panel 9, 10 by a rotational, i.e. tilting motion. The bottom flange 3 of the wall panel may exhibit a reciprocating counter channel 18 built to support the weight of the acoustic board 7 and rotational motion. This is best seen in FIG. 7a.

Yet in another embodiment, a solid 6 or an acoustic board 7 can be detached from an elongated wall panel 9, 10 by releasing a mechanical fastener 14, slightly lifting the board 6, 7 and pulling the panel 6,7 outwardly. Further sound attenuation material 39 can complement plant bedding material tile 22 if the plant bedding material tile 22 coverage inside the wall panel 1 should be insufficient. This is best seen in FIGS. 7a and 7b.

FIG. 7b discloses an embodiment where the board 6, 7 is mounted to the elongated wall panel 9, 10 by the longitudinal edges of the board 6, 7 being wedged in a respective reciprocating counter channel 18 in the top and bottom flanges 2, 3. This configuration provides a high security against tampering with the internal elements of modular wall 100. The board 6, 7 can be detached from the elongated wall panel 9, 10 by pulling the panel 6,7 outwardly.

Both the solid and acoustic boards 6, 7 can be fabricated of metallic or non-metallic material and can be shipped from factory with or without mounting device/s. In addition, at least one of the boards 6, 7 can ship from factory already coupled to a plant bedding material casing 30 with or without any tile disposed inside the casing 30.

The two shown exemplary methods of coupling boards 6, 7 to at least one flange 2, 3 of the wall panel 1 merely represent preferred methods. There can be several other methods that accomplish the stated purposes above.

FIG. 5a shows a perspective view of a seed/plant cup 25 and FIG. 5b shows a partial enlarged section of a seed/plant cup 25 inserted into a modular elongated, single-sided wall panel 9. The principle is equally applicable to a double-sided wall panel 10.

FIG. 5a shows a perspective view of a seed/plant cup 25 with a plant 21 planted in the cup's 25 plant bedding material 26. The figure shown has a top mounting ring 28 configured to extend out from the surface of a solid or the acoustic board 6, 7 while the concealed portion of the cup 25 is configured to decline through the casing 30 opening 32 into the opening 27 in the plant bedding material tile 22. The cup's 25 dimensions can be configured to match standard industry cup dimensions as sold in major national home and garden stores. In fact, this innovation foresees home and garden stores' nurseries providing the seed/plant cups 25 to consumers.

The seed/plant cup 25 can be made of organic or non-organic material with perforated openings 34 to enable the plant's roots 23 to grow into the plant bedding material tile 22 inside the wall panel 1. In at least one embodiment, the edges 35 of the perforated openings 34 in the seed and plant cups 25 can be sharp. In addition, protrusion tab/s 29 built into the seed/plant cup 25 top ring 28 can enable rotating the seed/plant cup 25 about the cup's 25 central axis.

When the plant 21 has outlived its useful life, one can rotate the cup 25 and the sharp perforated opening edges 35 of the cup 25 can cut the roots 23, thereby enabling the extraction of the cup 25 from the plant bedding material tile 22. Additional information about the seed/plant cup can be found in the Applicant's application number U.S. Ser. No. 16/805,093 which is included by reference.

FIG. 5b shows a transverse section of a partial single-sided wall panel arrangement 1. The elongated C-shaped wall panel 9 with an exemplary arrangement comprises a plant bedding material tile 22 retained inside a casing 30 which in turn is coupled to a solid or acoustic board 6; 7. A seed/plant cup 25 is shown inserted through an opening 32 in the exterior face of the board 6, 7 into a corresponding cup bedding material opening 27 in the plant bedding material tile 22. The present figure shows an irrigation pipe 36 coupled to a bottom face of a top flange 2 of the elongated wall panel 9. The irrigation pipe 36 with an irrigation nozzle 37 is disposed in a mechanical key 5 formed in the flange 2. Irrigation fluid 20 conveyed through the irrigation pipe 36 is emitted onto a funnel 40 that carries the fluid 20 to the root base 23 of the seed/plant cup and/or its vicinity. The irrigation fluid can saturate the plant bedding material tile 22 with fluid flowing from the top of the plant bedding material tile 22 to below or, as shown in this figure, can be directed through the funnel 40 to arrive in proximity to a seed/plant cup 25 root base structure 23. From there fluid can travel in all directions inside the plant bedding material tile 22.

This method can save irrigation fluid 20 and reduce root proliferation across the bedding material tile 22. In another non-funnel 40 configuration, the fluid is instead configured to flow from the top surface of the bedding material tile 22 downwardly. The one or more funnels 40 are preferably configured to be substantially vertically aligned with the one or more cup bedding material openings 27 in the plant bedding material tile 22. Other elements shown include an irrigation pipe 36 with an irrigation nozzle 37, a coupling fastener 19 that couples the casing 30 of the plant bedding material tile 22 to the solid/acoustic board 6, 7, and mechanical fasteners 14 coupling the board 6, 7 to the top flange 2 of the elongated wall panel 9. Although FIG. 5b discloses as single-sided elongated wall panel 9, the same principle is equally applicable to a double-sided wall panel 10.

Further, the top and bottom flanges comprise weep holes 41 allowing a draining of irrigation fluid.

FIGS. 6a and 6b show in perspective view mechanical means to couple the plant bedding material casing 30 to a board and a single-sided elongated wall panel 9, respectively. Although FIGS. 6a and 6b illustrate an acoustic board, the same principle is equally applicable to a solid board.

FIG. 6a shows in perspective view an exemplary means to couple a plant bedding material casing 30 to a board 6, 7. The present figure shows continuous strips of Velcro-type fasteners 19 longitudinally disposed in proximity to the top and the bottom ends of the inner side of the board 6, 7, and reciprocating longitudinal fastener 19 strips in proximity to the exterior facing's top and the bottom of the plant bedding material casing 30. The arrangement allows for shipping the boards 6, 7 either coupled or not coupled to the plant bedding material casing 30. The plant bedding material tiles 22 can be shipped disposed inside their respective casings 30, or instead, to be mounted with the casings 30 in the field. Furthermore, in at least one embodiment, the plant bedding material tile 22 or the plant bedding material tile 22 with its casing 30 can be detached and replaced with new boards 6,7 and/or casings 30.

FIG. 6b shows in perspective view a preferred means to couple a plant bedding material tile casing 30 to the vertical wall 4 of an elongated wall panel 9. Although a single-sided elongated wall panel 9 is illustrated, the principle is equally applicable to a double-sided elongated wall panel 10. The present figure shows continuous strips of Velcro-type fasteners 19 disposed in proximity to the longitudinal top and bottom ends of the back side of the plant bedding material casing 30 and reciprocating fastener 19 strips in proximity to the longitudinal top and bottom of the inner vertical wall 4 of the wall panel 9. The arrangement allows for shipping the panel wall 1, 9 with or without the plant bedding material casing 30 coupled, and with or without the plant bedding material tiles 22 disposed inside the casing 30. Furthermore, in at least one embodiment, the bedding material casing 30 and/or the bedding material tile 22 is detachable and can be replaced. The present figure is primarily suited to applications where the board 6, 7 can be removed, thereby exposing the internal elements inside the wall panel 1, 9.

The mounting methods described for FIGS. 6a and 6b are exemplary methods. Other mounting methods for mounting the plant bedding material tile 22, the plant bedding material tile 22 inside the casing 30, and the solid or acoustic board 6, 7 can include at least one of: bonding, riveting, screwing, lamination, and spiking. Also, the mounting methods are equally applicable in the event the elongated wall panel should be a double-sided wall panel 10.

FIGS. 7a and 7b show exemplary methods of removable and fixed coupling of the solid/acoustic board 6, 7 to the flanges 2, 3 of the wall panel 1, respectively. Although the methods are illustrated in view of a single-sided wall panel 9, the mounting methods are equally applicable in the event the elongated wall panel should be a double-sided wall panel 10.

FIG. 7a shows a transverse section of the wall panel 1 with an exemplary solid/acoustic board 6, 7. The board 6, 7 is coupled to a casing 30 containing the plant bedding material tile 22. The present figure shows the longitudinal bottom of a board 6, 7 resting inside a reciprocating channel 18 built into the bottom flange 3. In proximity to the top end of the longitudinal board 6, 7, at least one bore 13 in the board 6, 7 is configured to receive at least one fastening device 14 that fastens the board 6, 7 to a reciprocating receiving structure built into the top flange 2 of the wall panel 9 and/or directly coupled to it. This board 6, 7 mounting method enables coupling the solid or acoustic board 6, 7 with the plant bedding material tile 22 and casing 30 complete to the wall panel 1, 9. It also enables easy access to the interior of the wall panel 9 when at least one of: the plant bedding material tile 22, the casing 30, an irrigation fitting 36, 37, 38, and/or an electrical fitting/device 42 needs to be replaced. The installer then simply removes the at least one tamper proof or non-tamper proof mechanical fastening device 14 and pulls down the solid/acoustic board 6, 7 from the top side in a rotational, tilting motion as shown in the figure. A coupled enlargement shows in more detail the coupling detail of a board 6, 7 to the top and bottom flanges 2.

FIG. 7b shows a transverse section of the elongated wall panel 9 with an exemplary solid/acoustic board 6, 7 coupled. The board 6, 7 can be coupled to the top and the bottom flanges 2, 3 of the wall panel 1. The present figure shows the top and the bottom longitudinal ends of the solid/acoustic board 6, 7 captured in a wedged manner inside the counter channels 18 formed in the top and bottom flanges 2, 3. This exemplary method to secure the solid or acoustic board 6, 7 to the wall panel 9 is one among several mounting methods that can be utilized. Common to all methods is that the solid or the acoustic board 6, 7 is secured in position during the process of erecting the modular wall 100. This method may require removing above wall panel/s if an interior element inside the wall panel 1 needs replacing. A coupled enlargement shows in more detail the coupling detail of a board 6, 7 to the top and bottom flanges 2, 3.

The methods of mounting the solid or acoustic board 6, 7 to the wall panel 1, as shown in FIGS. 7a and 7b, can include plant material tile 22 and/or plant bedding material tile 22 inside casing 30. However, in a different embodiment, the solid or acoustic board 6, 7 can only incorporate noise absorbing material and/or at least one device that must be out of reach inside the wall panel 1.

FIGS. 8a and 8b show partial sections of single- and double-sided wall panels 9, 10 with solid/acoustic boards 6, 7 and plant material 21. FIG. 8c shows a partial section of back-to-back, single-sided wall panels 9 with a gap 11 between two single-sided wall panels 9.

FIG. 8a shows a partial transverse section of a single-sided elongated wall panel 9 with a plant bedding material tile 22 inside a casing 30 coupled to a solid/acoustic board 6, 7, with plants 21 growing from a seed/plant cup 25 at the modular wall's 100 exterior. The seed/plant cup 25 is inserted through an opening 32 in the board 6, 7, growing roots 23 inside the plant bedding material tile 22. The entire modular wall 100 described above is formed by coupling the same or different elongated wall panels 9 from above and below. The wall panels 9 are keyed to one another by a mechanical key 5 that can be configured into the profile of the top and/or the bottom flange/s 2, 3 of the wall panels 1. Above the plant bedding material casing 30, a continuous irrigation pipe 36 is shown with an irrigation nozzle 37. The irrigation pipe 36 shown is coupled to the bottom face of the top flange 2 of the wall panel 9. In another embodiment, the irrigation pipe 36 can be disposed on the top surface of the bottom the wall panel 9 bottom flange 3. In yet another embodiment, no irrigation pipe is needed, and the bottom flange 3 of the wall panel 1 conveys irrigation fluid 20 to the plant bedding material tile 22. Weep holes 41 are arranged in the top and bottom flanges 2, 3 allowing a flow of irrigation fluid between the stacked elongated wall panels 9.

FIG. 8b shows a partial transverse wall panel section of a double-sided elongated wall panel 10 retaining at least one plant bedding material tile 22 and/or a solid or acoustic board 6, 7 on both sides of the modular wall 100. It is realized that one side can be provided with plant bedding material tiles 22 to allow cultivation, whereas the other side of the modular wall 100 can be provided with solid/acoustic panels 6, 7. In this figure, the plant material 21 can grow from both sides of the wall 10 wherein a common vertical wall 4 of the elongated wall panel 10 is disposed between the two openings retaining the plant bedding material tiles 22.

FIG. 8c shows a partial transverse section of a wall with back-to-back single-sided wall panels 9, with an air gap 11 between. In another embodiment, a barrier member 12 can be disposed between the vertical walls 4 of the wall panels 1, 9. The barrier member 12 can be selected to withstand ballistic projectiles, reduce sound transmittance, and incorporate sensing devices and/or other electronic or mechanical conductors requiring a chase. The entire wall assemblies 1 shown in FIGS. 8a, 8b and 8c are wedged between flanges of vertical posts 8 disposed at both ends of the wall panels 1 that together comprise the modular wall 100 assembly

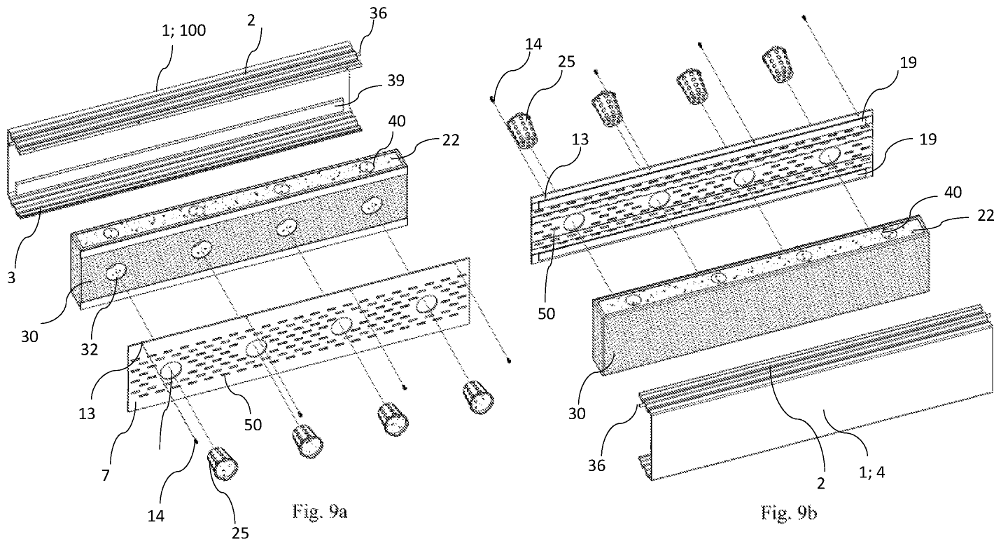

FIGS. 9a and 9b show front and back exploded perspective views of a section of the modular wall 100, wall panel 1 assembly with an irrigation pipe 36 and sound attenuation 39 strips, including the plant bedding material tile 22, the casing 30 with coupling fasteners 19, an acoustic board 7 with coupling fasteners 19, seed/plants cups 25, and mechanical fasteners 14 respectively.

The embodiments and examples set forth herein are presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in the light of the teachings above without departing from the spirit and scope of the forthcoming claims.

Especially, the skilled person realizes that the elongated wall panels 9, 10 may comprise a plurality of plant bedding material tiles 22 and boards 6, 7 arranged side by side along their longitudinal directions. Thus, the tiles 22 and boards 6, 7 may each have a length that is substantially shorter than the respective elongated wall panel 9, 10. Also, one and 5 the same elongated wall panel 9, 10 may, along its longitudinal extension be provided with a mixture of plant bedding material tiles 22, sound attenuating material tiles, acoustic boards 7 and non-acoustic boards 6. Further, the skilled person realizes that the pattern of openings 50 in the acoustic boards 7 may vary. Also, the same sound attenuating effect may be achieved by recesses.

ELEMENTS LIST

| | |
|---|---|
| 1. | Arrangement of wall panels |
| 2. | Top flange |
| 3. | Bottom flange |
| 4. | Vertical wall |
| 5. | Mechanical key |
| 6. | Solid board |
| 7. | Acoustic board |
| 8. | Vertical post |
| 9. | Single sided wall panel |
| 10. | Double sided wall panel |
| 11. | Air gap |
| 12. | Barrier member |
| 13. | Bore |
| 14. | Mechanical fastener |
| 15. | Protrusion |
| 16. | Protective membrane |
| 17. | Acoustic board bottom |
| 18. | Counter channel |
| 19. | Coupling fastener |
| 20. | Fluid |
| 21. | Plant/s |
| 22. | Plant bedding material tile |
| 23. | Root/s |
| 24. | Seed/s |
| 25. | Seed/plant cup |
| 26. | Bedding material |
| 27. | Cup bedding material opening |
| 28. | Top mounting ring |
| 29. | Cup protrusion tab |
| 30. | Casing |
| 31. | Top surface opening |
| 32. | Plant cup opening |
| 33. | Mechanical keying apparatus |
| 34. | Perforated opening |
| 35. | Opening edge |
| 36. | Irrigation pipe |
| 37. | Irrigation nozzle |
| 38. | Irrigation fitting |
| 39. | Sound Attenuating Material |
| 40. | funnel |
| 41. | Weep hole |
| 42. | Electrical fitting/device |

1. A modular wall system comprising a plurality of elongated wall panels disposed on one another, a plant bedding material tile, a seed/plant cup, a board, and an irrigation pipe, wherein:
the elongated wall panels comprise a vertical wall, a top flange and a bottom flange;
the fluid emitting irrigation pipe is disposed on and/or couples to at least one of the top and bottom flanges of an elongated wall panel;
the board comprises at least one opening configured to receive a seed/plant cup, and wherein the board is coupled to at least one of the flanges of the elongated wall panel, thereby forming a wall panel interior;
the plant bedding material tile is configured to be coupled to an interior vertical wall portion of the elongated wall panel and/or to an interior wall portion of the board;
the seed/plant cup is configured to be inserted from the outside through the at least one opening in the board to thereby be partially disposed inside a cup bedding material opening of the plant bedding material tile; and wherein
once irrigated by a fluid supply provided by the fluid emitting irrigation pipe, a seed/plant in the seed/plant cup disposed inside the plant bedding material tile is configured to grow roots into the plant bedding material tile and grow a canopy extending from an exterior of the board.

2. The modular wall system according to claim 1, wherein the board is an acoustic board, or wherein the board is a non-acoustic board.

3. The modular wall system of claim 1, wherein the board has at least one sound attenuation through opening.

4. The modular wall system of claim 1, wherein the board comprises a bore configured to couple the board to the elongated wall panel by means of a mechanical fastener.

5. The modular wall system of claim 1, wherein board is removably fixated between the top and bottom flanges of the elongated wall panel.

6. The modular wall system of claim 1, wherein the modular wall system comprises at least two single-sided or double-sided elongated wall panels.

7. The modular wall system of claim 1, wherein a flange of a first elongated wall panel is configured to be coupled to a flange of a second elongated wall panel by at least one reciprocating mechanical key.

8. The modular wall system of claim 1, wherein the top and bottom flange of the elongated wall panel comprise one or more weep holes.

9. The modular wall system of claim 1, wherein the plant bedding material tile comprises at least one funnel, the at least one funnel being configured to be substantially vertically aligned with a respective cup bedding material opening in the plant bedding material tile.

10. The modular wall system of claim 1, wherein the plant bedding material tile is configured to be coupled to the board and/or to a plant bedding material casing.

11. The modular wall system according to claim 1, wherein the elongated wall panels, partially or fully, are made of a bio-degradable material.

12. The modular wall system according to claim 1, wherein the board, partially or fully, is made of a bio-degradable material.

13. A modular wall formed by the use of modular wall system according to claim 1, wherein a plurality of elongated wall panels are arranged in a stacked relationship, one on top of the other, between at least two vertically extending posts.

14. The modular wall according to claim 13, wherein the modular wall is formed by at least two single-sided or double-sided elongated wall panels and wherein at least one of the sides of the modular wall comprises a plurality of seed/plant cups.

15. An elongated wall panel to form part of a modular wall system according to claim 1, wherein the elongated wall panel is partially or fully, made of a bio-degradable material.
